(19) United States
(12) Patent Application Publication
(10) Pub. No.: US 2007/0156512 A1
(43) Pub. Date: Jul. 5, 2007

(54) System and method for modeling an asset portfolio and predicting performance thereof

(75) Inventor: Jason Yerkie, Bethesda, MD (US)

Correspondence Address: BUCHANAN, INGERSOLL & ROONEY PC, POST OFFICE BOX 1404, ALEXANDRIA, VA, 22313-1404, US

(73) Assignee: Lockheed Martin Corporation, Bethesda, MD (US)

(21) Appl. No.: 11/525,097

(22) Filed: Sep. 22, 2006

Related U.S. Application Data
(60) Provisional application No. 60/720,425, filed on Sep. 26, 2005.

(51) Int. Cl. H04M 3/51; G06Q 40/00; G06F 11/34

(52) U.S. Cl. 705/11; 705/35

(57) ABSTRACT

Systems and methods are disclosed that forecast or predict the performance of an organization or business unit within the organization. The forecast is generated by storing asset and performance data in a database. A user may request the asset and performance data associated with a particular business unit based on a number of user inputs. A processor extracts the requested data from the database and calculates a performance forecast by using trend analyses and performance metrics ratios on the requested asset and performance data.

### BACKGROUND

This application claims priority under 35 U.S.C. §119 of U.S. Provisional Application No. 60/720,425, filed on Sep. 26, 2005. The entire contents of the above-identified provisional application are hereby incorporated by reference.

Systems and methods are disclosed for modeling an asset portfolio and predicting performance thereof.

Real property assets can impose financial and legal exposure on an organization. Real property ownership and facility costs are incurred in the operation of nearly any organization, regardless of purpose, size, or country of origin.

Organizations often manage and strategically plan assets, such as employees, information technology, proprietary knowledge/expertise, work processes, and other types of assets. However, real property assets are often viewed as operational necessities. As a result, organizations focus on the day-to-day maintenance and management of individual real property assets.

An exemplary embodiment is a system that models an asset portfolio and predicts performance thereof. The system includes a database that stores asset and performance data. A user interface is configured to request asset and performance data of a group from the database based on a user input. A processor is configured to generate a performance forecast by performing trend analysis on the requested asset and performance data based on data associated with the group.

An exemplary method is disclosed for modeling an asset portfolio to predict performance thereof. The method includes extracting asset and performance data of a group from a database. The extracted asset and performance data is used in calculating a performance forecast of the group in a trend analysis calculation. The method also includes displaying the performance forecast in a graphical interface.

Another exemplary system models an asset portfolio and predicts performance thereof. The system includes means for storing the asset and performance data in a database, and interface means for requesting asset and performance data of a group from the storage means based on a first user input. The system also includes means for generating a performance forecast by relating the requested asset and performance data of the group to strategic data of the group in a trend analysis calculation, and means for graphically displaying the performance forecast.

A computer readable medium is disclosed that models an asset portfolio and predicts the performance thereof. The computer readable medium includes an interface module that generates a user interface for sending projected asset and performance data of a group to a database, requesting the projected asset and performance data of the group and current asset and performance data of the group from the database, and displaying a graphical representation of a performance forecast based on relationships between the projected asset and performance data of the group and the current asset and performance data of the group. The computer readable medium also includes a processing module that calculates the performance forecast by using the projected asset and performance data of the group, current asset and performance data of the group, and strategic data of the group through a trend analysis calculation. Still further, the computer readable medium includes a display module that generates a graphical representation of the performance forecast.

In the following, exemplary embodiments will be explained with greater detail in reference to drawings, wherein:

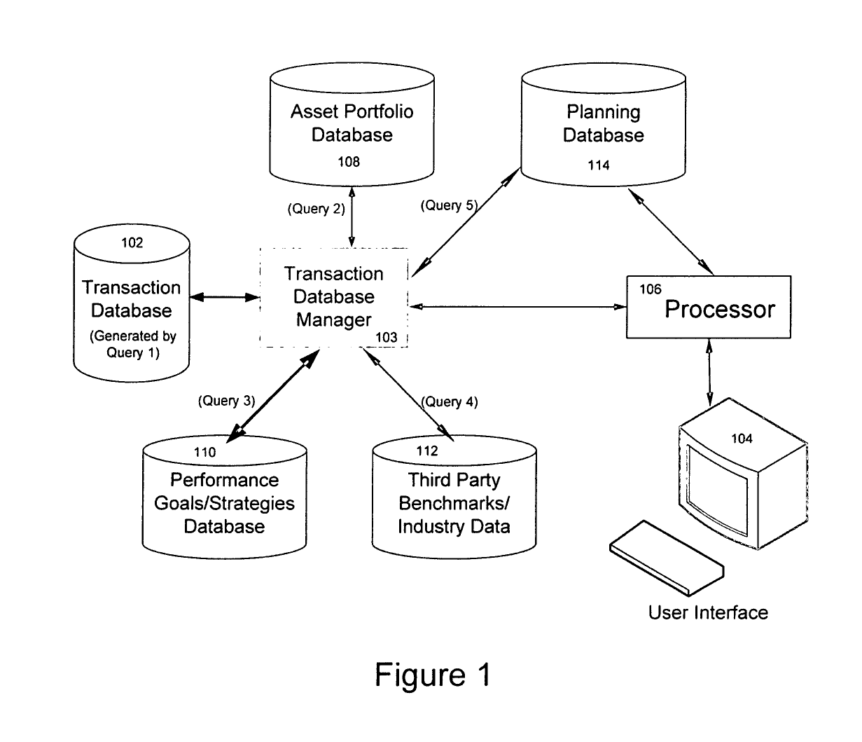

FIG. 1 illustrates a system that forecasts performance in accordance with an exemplary embodiment;

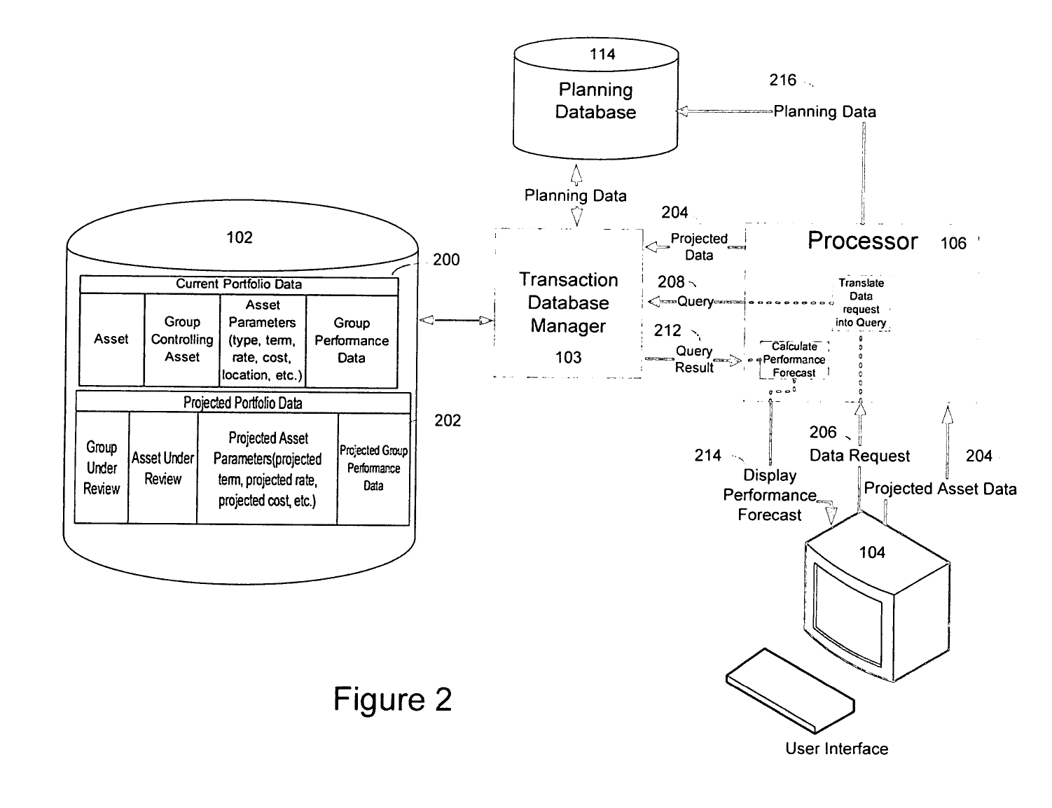

FIG. 2 is a block diagram illustrating an exemplary flow of system data in accordance with an exemplary embodiment;

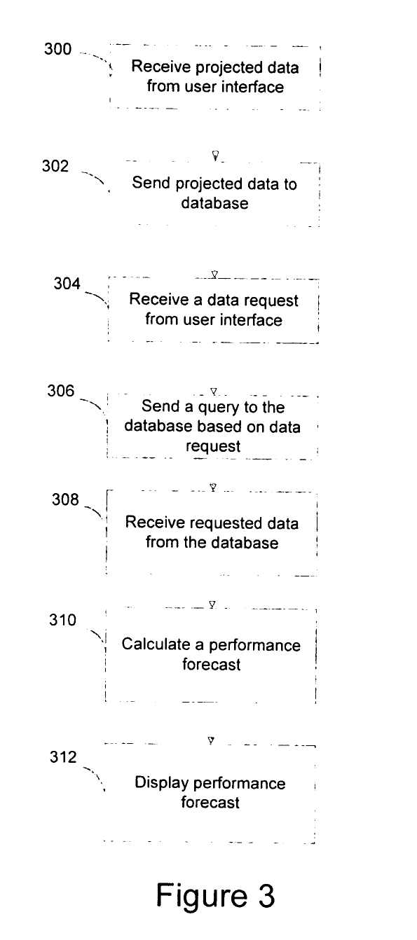

FIG. 3 is a flow diagram that illustrates a process for calculating a performance forecast in accordance with exemplary embodiments;

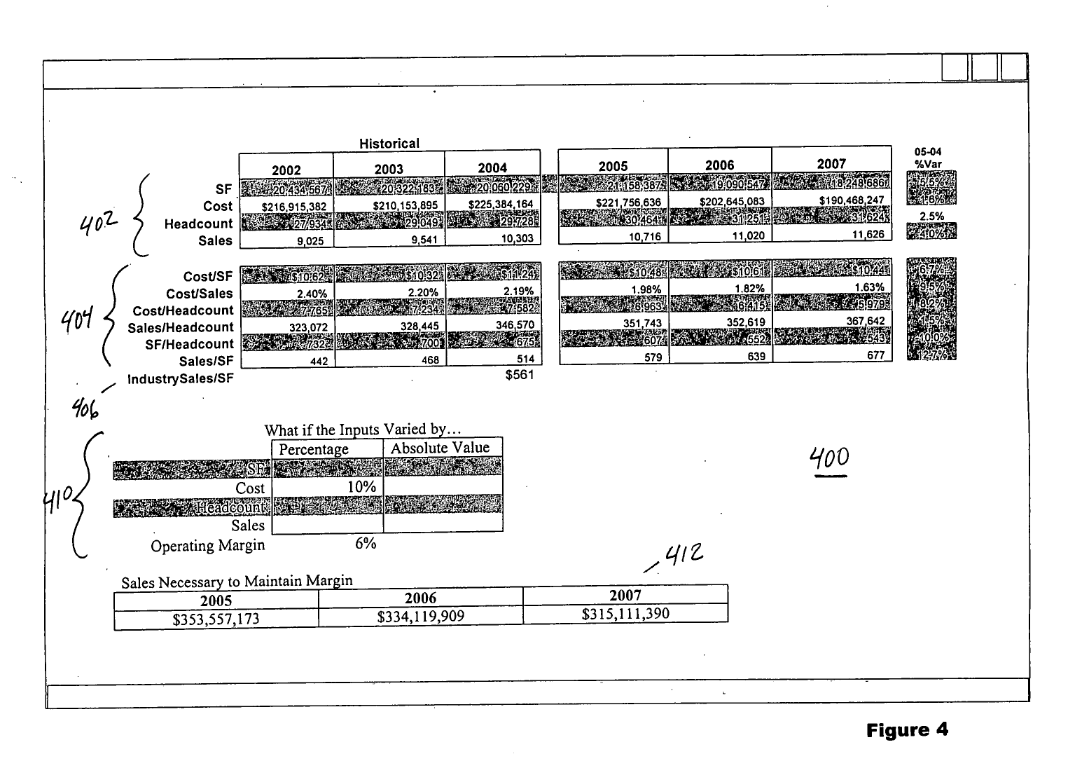

FIG. 4 illustrates a summary view used to display a performance forecast in accordance with exemplary embodiments;

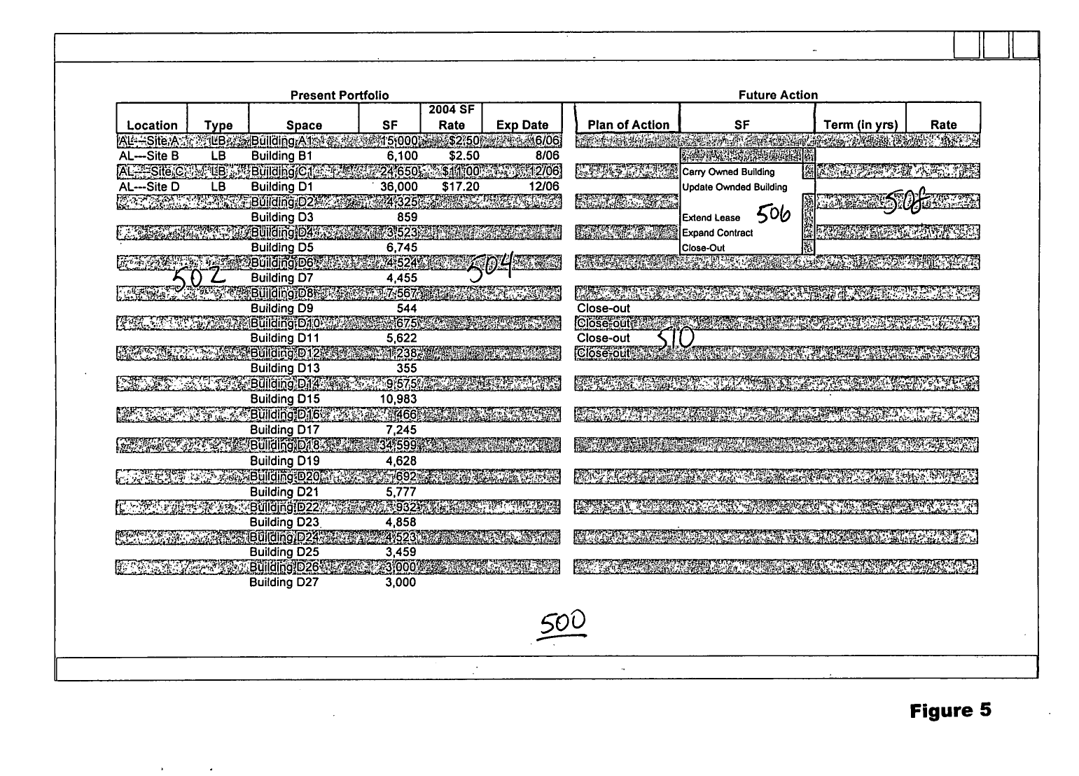

FIG. 5 illustrates a main window in a detailed view used to display a performance forecast in accordance with exemplary embodiments;

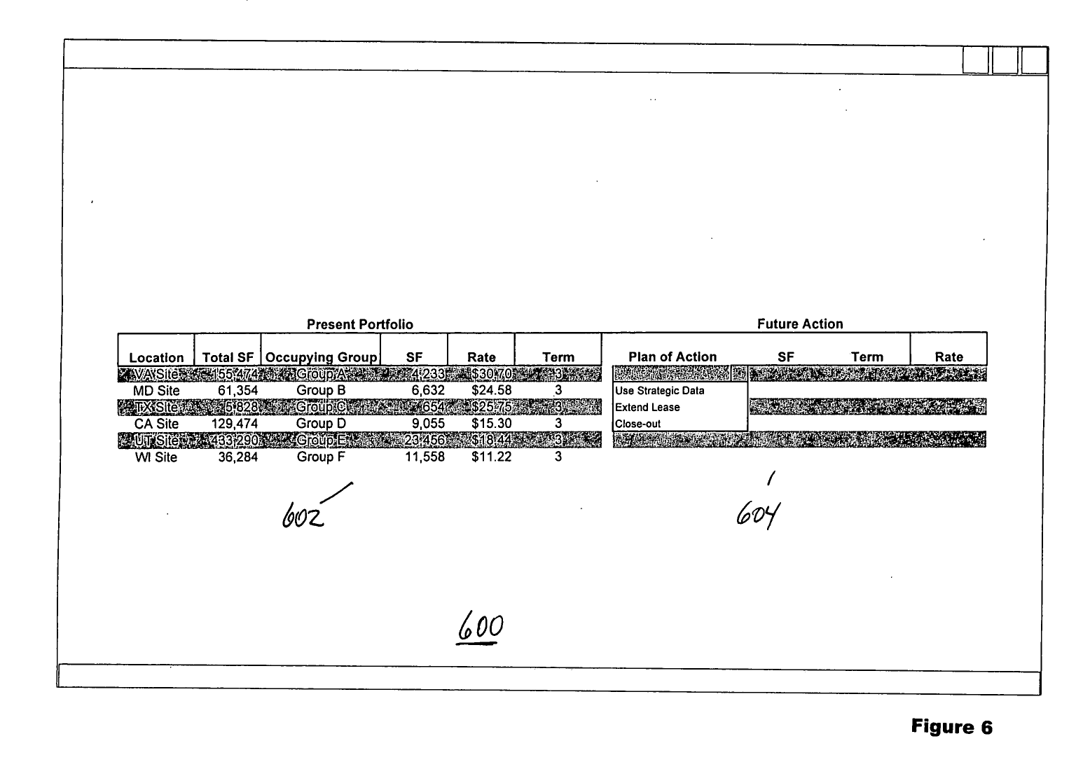

FIG. 6 illustrates a sub-window of the detailed view in accordance with exemplary embodiments;

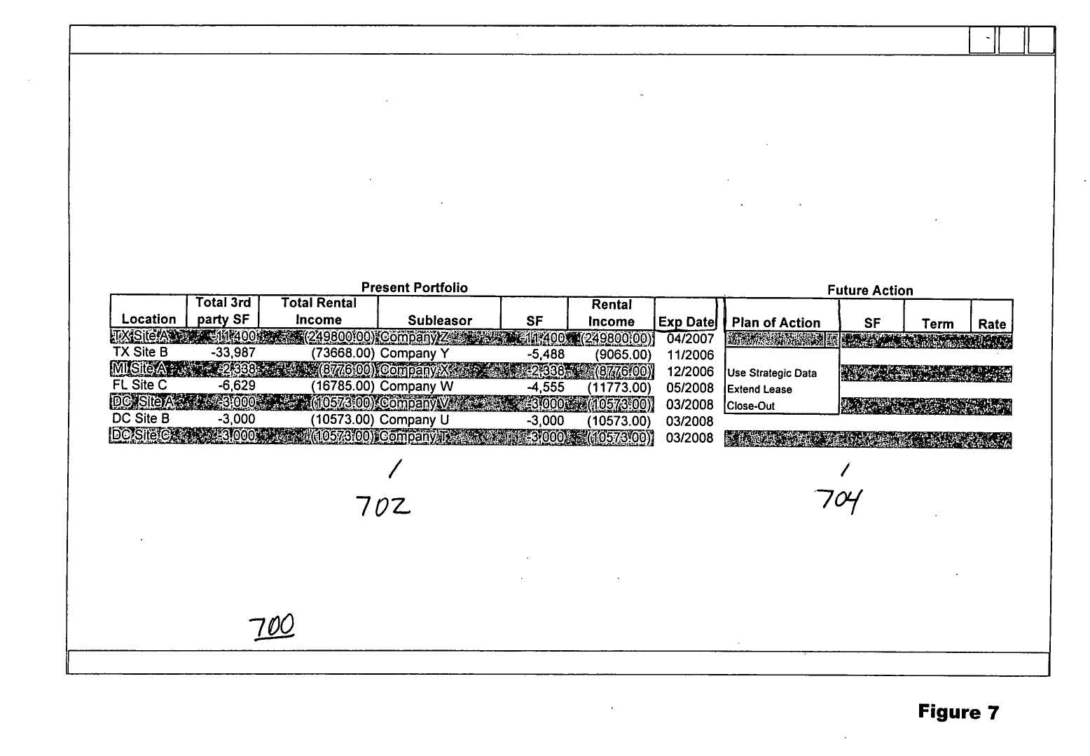

FIG. 7 illustrates a sub-window of the detailed view in accordance with an exemplary embodiment;

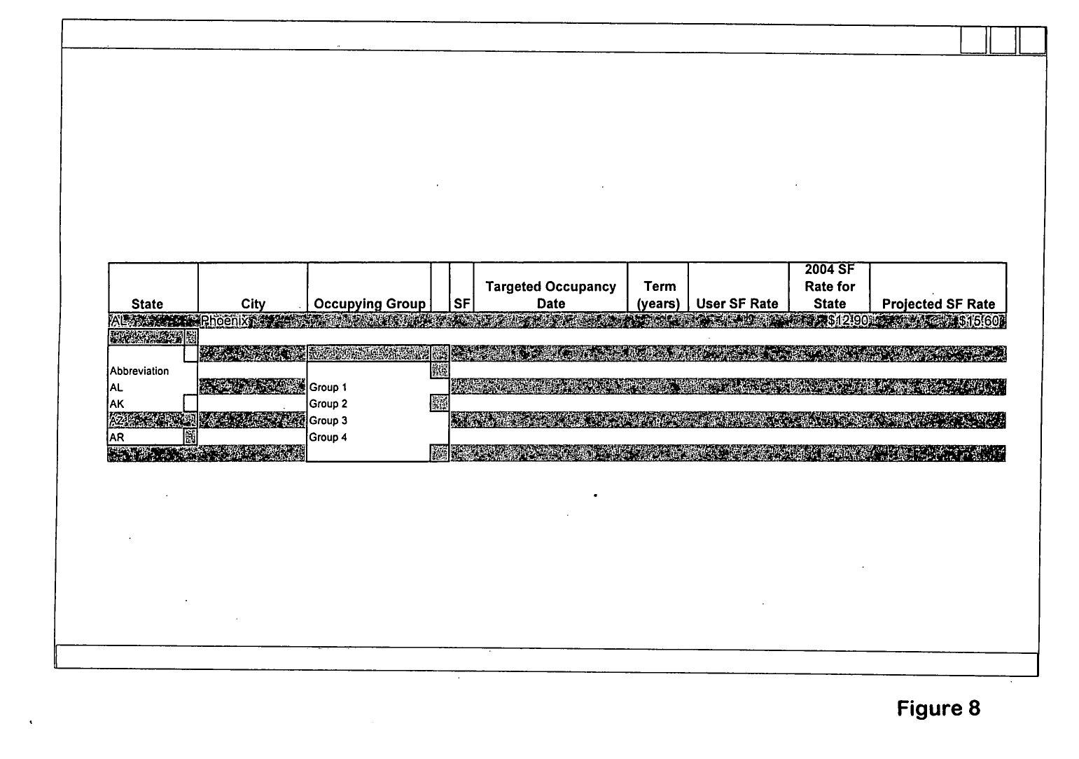

FIG. 8 illustrates a sub-window of the detailed view in accordance with an exemplary embodiment;

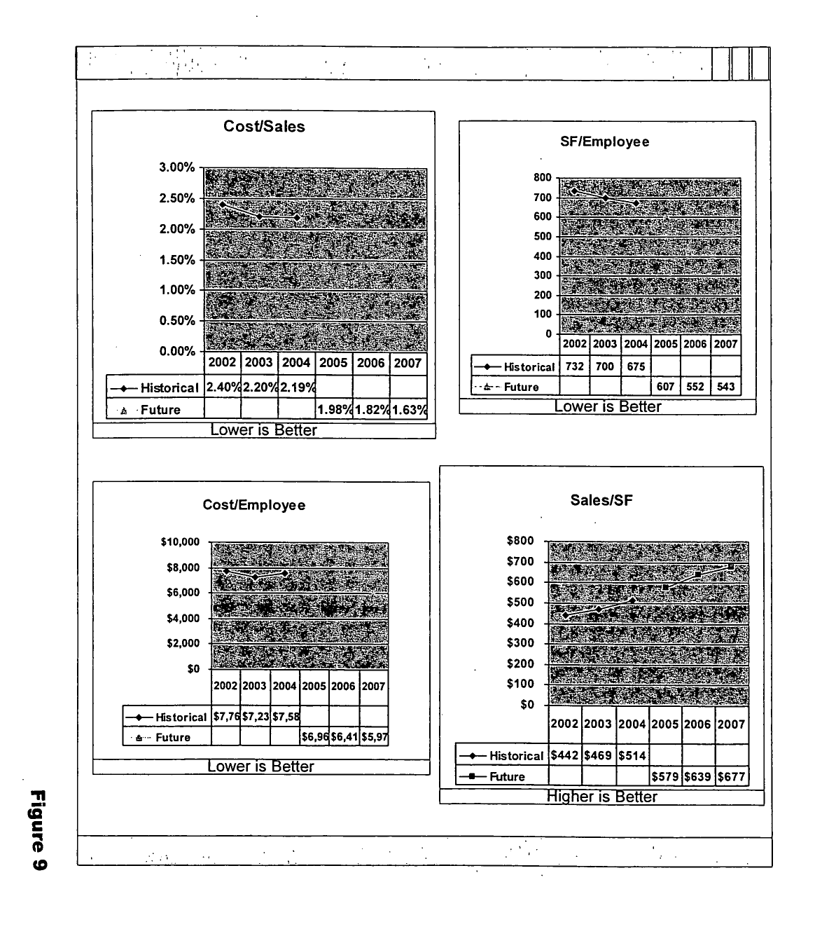

FIG. 9 illustrates a sub-window of the detailed view in accordance with an exemplary embodiment; and

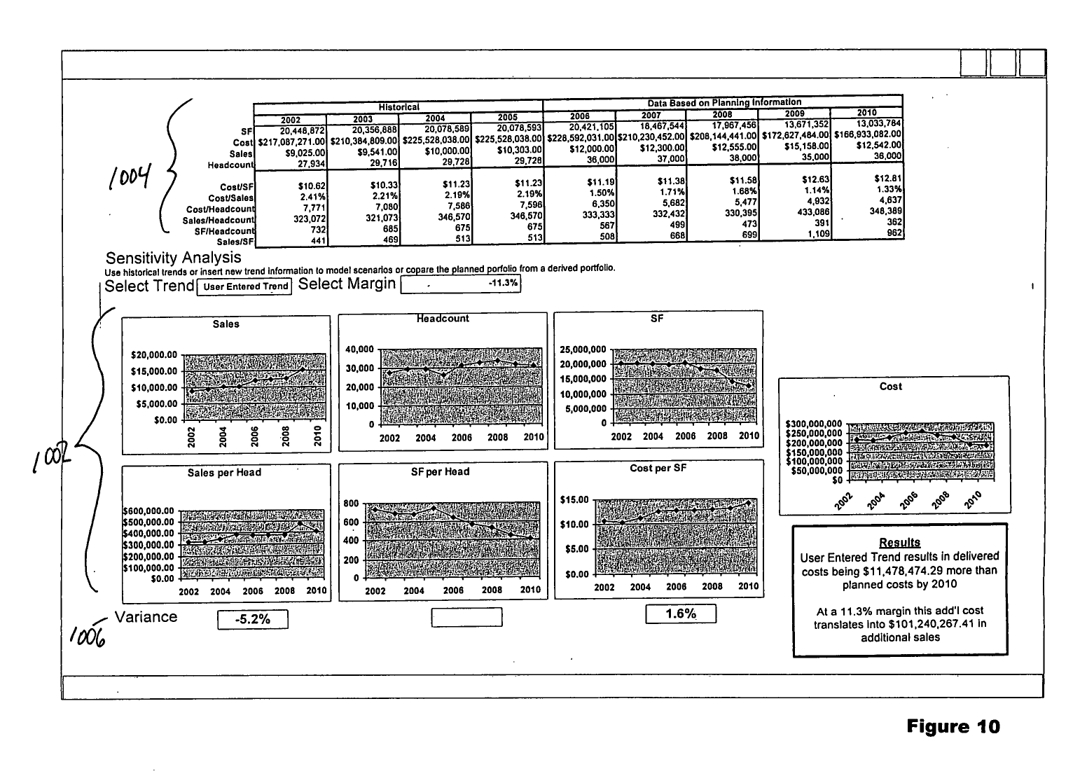

FIG. 10 illustrates a sub-window of the summary view in accordance with an exemplary embodiment.

FIG. 1 illustrates an exemplary system 100 that models an asset portfolio and predicts performance thereof in accordance with an exemplary embodiment. The system 100 includes a transaction database 102, a user interface 104, and a processor 106. Although only one instance of the transaction database 102, the user interface 104, and the procession 106 is shown, the system may include any number of the aforementioned databases.

The transaction database 102 is configured to store asset and performance data that is associated with an organization and its underlying business units. The transaction database 102 gathers this asset and performance data from various other memory devices and databases on a network, which may include an asset database 108, a strategies database 110, an industry benchmark database 112, and a planning database 114. Those of skill in the art will appreciate that the various memory devices and databases on the network may store any data that is associated with assets or the performance of an organization or any of its business units.

The asset database 108 stores information that describes how each asset is used by the organization. The strategies database 110 stores information related to the performance goals of the organization. The industry benchmark database 112 stores accepted rates or figures according to the specified industry or group within the organization. The planning database 114 stores projected or future asset information that is input by a user and will be used at a later date. Because the manner in which data is stored in these other memory devices and databases varies, the transaction database 102 links all of the gathered data so that all data relationships are standardized.

For example, in an exemplary embodiment a transaction database manager 103 determines how each of the asset databases 108 identifies each asset and how responsibility of these assets are assigned to different groups within the organization. The transaction database manager 103 links key performance measures that are stored in the strategies database 110 to each asset gathered from the asset database 108. Further, the transaction database manager 103 links key performance measures of the organization or group, and each asset to industry figures and third party benchmarks that are gathered from the external industry benchmark database 112. Through the operations performed by the transaction database manager 103, the transaction database 102 links and relates all gathered information of a common storage location.

The transaction database manager 103 periodically queries each of the memory devices or databases from which information is gathered to determine whether any of the gathered information has changed. In the event that any of the gathered data values have changed, the transaction database manager 103 sends an alert signal to the processor 106 and/or extracts the newly updated data from the database of interest and stores the newly updated data in the transaction database 102.

The system 106 also includes the user interface 104. The user interface 104 may be a computer or other PC based device that is configured to request asset and performance data of a group from the transaction database 102 based on a user input through a graphical interface. The user interface 104 is also configured to send asset and performance data to the transaction database 102. The user interface 104 is configured to display the requested asset and performance information along with the performance forecast that is received from the processor 106 so that a user may determine the impact that a future or current business decision may have on performance or profitability of the organization.

The processor 106 is configured to generate a performance forecast by performing trend analysis calculations on the asset and performance data requested by the user interface 104. The processor 106 sends the trend analysis calculation results to the user interface 104 so that the performance forecast can be displayed to the user. In an exemplary embodiment, the processor may be a stand-alone device or may be integrated with the user interface 104 in a single device.

FIG. 2 is a block diagram illustrating an exemplary flow of data between the transaction database 102, the user interface 104, and the processor 106 in accordance with an exemplary embodiment of the invention.

As shown in FIG. 2, the transaction database 102 links the asset and performance data gathered from the asset database 108, the strategies database 110, the industry benchmark database 112, and the planning database 114 in a format exemplified by a current portfolio data structure 200, for example. The current portfolio data structure 200 links an asset 200a to a business unit (group) controlling the asset 200b, asset parameters 200c, and asset performance data for that (group) 200d.

The transaction database 102 also links a projected portfolio data structure 202 with the current portfolio data structure 200. The projected portfolio data structure 202 includes projected asset parameter data 202a and projected group performance data 202b both of which are received from the user interface 104 via the processor 106 based on a user input. The transaction database 102 links the projected portfolio data structure 202 with the current portfolio data structure 200 based on the name of the asset and/or the group controlling the asset.

Before a performance forecast can be calculated by the processor 106 and displayed to a user on the user interface 104, the user interface 104 sends projected asset data 204 and a data request 206 to the processor 106 based on respective user inputs. The processor 106 sends the projected asset data 204 to the transaction database 102, which stores the projected asset data 204 in the projected portfolio data structure 202 as discussed above. The processor 106 receives the data request 206 from the user interface 104 and translates the data request 206 into a query 208. Based on the query 208, the processor 106 extracts data from both the current portfolio data structure 200 and the projected portfolio data structure 202 of the transaction database 102. The transaction database 102 returns the extracted data to the processor 106 as a query result 212. The processor 106 calculates a performance forecast based on the query result 212 by performing a trend analysis calculation that compares and/or relates projected portfolio data of the projected portfolio data structure 202 to current portfolio data of the current portfolio data structure 200. The process of calculating the trend analysis is discussed in greater detail below. The processor 106 sends the performance forecast 214 to the user interface 104 so that the performance forecast is displayed to the user. The processor 106 may also send the projected asset data 204 to the planning database 114 as planning data 216. This action of the processor 106 is based on a user input at the user interface 104.

FIG. 3 is a flow diagram that illustrates an exemplary method for modeling an asset portfolio to predict performance thereof.

In a step 300, the processor 106 receives projected data 204 from the user interface 104. The processor 106 sends the projected data 204 to the transaction database 102, which stores the projected data 204 in the projected portfolio data structure 202 (step 302). In a step 304, the processor 106 receives a data request 206 from the user interface 104. The processor 106 translates the data request 206 into a query 208, and sends the query 208 to the transaction database manager 103 (step 306). The transaction database manager 103 extracts asset and performance data from the transaction database 102 based on the query 208. The transaction database manager 103 sends the extracted data to the processor 106 as a query result 212 (step 308). The processor 106 receives the query result 212 from the transaction database 102 (step 310). The query result 212 includes data of the current portfolio data structure 200 and projected portfolio data structure 202 that correspond to parameters provided in the query 208. The processor 106 calculates a performance forecast 214 using the extracted asset and performance data of the query result 212 in a trend analysis calculation (step 312). The processor 106 sends the performance forecast 214 to the user interface 104 so that the user interface 104 may display the performance forecast 214 in a graphical interface to the user.

The exemplary embodiments of the invention will now be described through an example in which an organization generates a performance forecast based on its real property portfolio. In this example, for each real property asset the transaction database 102 stores data that includes, but is not limited to, a building name, an address, square footage numbers, a building type, a lease end date, and lease renewal options. The transaction database 102 also stores cost and key organizational performance measures that are associated with each real property asset. These measures may include, for example, revenue values, number of products produced, profit margins, and head count numbers. The transaction database manager 103 gathers all of the aforementioned data from various memory devices and databases that are internal and/or external to a local area network of the organization. The transaction database manager 103 gathers industry related performance benchmarks and other key industry measures from third-party and industry databases over a wide-area network, such as the Internet, and sends the measures to the transaction database 102 for storage.

The transaction database manager 103 gathers the data from the various other memory devices and databases through queries. Tables 1-3 provide examples of queries that may be generated to build the transaction database 102 in a real estate portfolio environment. In particular, Table 1 provides an example of a query used to generate the transaction database in accordance with an exemplary embodiment of the invention.

TABLE 1
SQL 1-Creates the Actual and Projected Tables in Transaction DB

CREATE TABLE Actual_Table
(Organizational_Entity CHAR,
Time_Period DATE,
Revenue NUMERIC,
Headcount NUMERIC,
Building-Identifier CHAR,
Square_Footage NUMERIC,
Occupancy_Cost_Per_Square_Foot NUMERIC,
Ownership_Type CHAR,
Lease_Termination_Date DATE,
Future_Plan_for_Building CHAR,
Actual CHAR)
CREATE TABLE Projected_Table
(Organizational_Entity CHAR,
Time_Period DATE,
Revenue NUMERIC,
Headcount NUMERIC,
Building-Identifier CHAR,
Square_Footage NUMERIC,
Occupancy_Cost Per_Square_Foot NUMERIC,
Ownership_Type CHAR,
Lease_Termination_Date DATE,
Future_Plan_for_Building CHAR,
Projected CHAR)

Table 2 illustrates an example of query code used to extract data from a real-estate asset database and store the data in the transaction database 102, in accordance with an exemplary embodiment of the invention.

TABLE 2
SQL 2-Inserts Data from Real Estate
Database into the Transactions DB

INSERT INTO Actual_Table (Organizational_Entity, Time_Period,
Building Identifier,
=Square=Footage, Occupancy=CostPerSquare−=Foot, Ownership_Type,
=Lease_Termination_Date, Future_Plan_for_Building, Actual)
SELECT PropertyTABLE.Responsible_Entity,
PropertyTABLE.Active_in_Time_Period,PropertyTABLE.Building
Identifier,
=PropertyTABLE.Square_Footage,
PropertyTABLE.Occupancy.Cost_Per_Square_Foot,
PropertyTABLE.Lease_Termination_Date,
PropertyTABLE.Future_Plan_for_Building, ‘A’
FROM Function_Real_Estate_DB

Table 3 illustrates an example of query code used to extract data from a strategies database and store the data in the transaction database 102, in accordance with an exemplary embodiment of the invention.

TABLE 3
SQL 3-Inserts data from Organizational Performance
Database into the Transactions DB

INSERT INTO Actual_Table (Organizational_Entity, Time_Period,
Revenue,
=Headcount, Actual)
SELECT
Forecasted_Operational_PerformanceTABLE.Organizational_Entity,
Forecasted_Operational_PerformanceTABLE.Valid_For_Time_Period,
Forecasted_Operational_PerformanceTABLE.Revenue,
Forecasted_Operational_PerformanceTABLE.Headcount, ‘A’
FROM Oganizational_Performance_DB

The transaction database manager 103 links the data gathered through the queries into the current portfolio data structure 200 of the transaction database 102.

At the user interface 104, an officer of the organization may insert information to generate a performance forecast for an individual business unit within the organization. In this example, the entered data is associated with a real estate asset which is the subject of a pending or contemplated real estate transaction. The officer may enter projected asset data 204 based on the selection of the individual group. The projected asset data 204 may include a maximum year for the projection calculations, revenue and head count projections, and any other dynamic values or figures which may affect the asset such as cost or lease escalations, for example. [00391 The processor 106 receives the projected asset data 204 from the user interface 104 and sends it to the transaction database manager 103. The transaction database manager 103 generates the projected portfolio data structure 202 of the transaction database 102 based on a query, as shown for example in Table 4.

TABLE 4
SQL 4-Inserts data entered by user
in Processor to the Transactions DB

GET Organizational_Entity, Time_Period, Revenue,
Headcount, Building=−Identifier,
Square_Footage, Occupancy_Cost_Per_Square_Foot,
Ownership_Type,
=Lease_Termination_Date, Future_Plan_for_Building, Actual
FROM Application_Interface
INSERT INTO Projected_Table (Organizational_Entity,
Time_Period, Revenue,
Headcount, Building−=Identifier, Square_Footage,
Occupancy_Cost_Per_Square_Foot,
Ownership_Type, Lease_Termination_Date,
Future_Plan_for_Building, Projected)

Based on the selected group, the user interface 104 generates a data request 206, which is sent to the processor 106. The processor 106 generates the query 208 based on the data request 206 to retrieve the projected asset data 204 and associated portions of current or historical asset data stored in the current portfolio data structure 200 of the transaction database 102. An example of the query 208 is shown, for example, in Table 5.

TABLE 5
SQL 5-Data Entered into Processor Created compares Actual
Sales in 2009 to Projected Square Footage in 2009

SELECT Actual_Table.Revenue,
Projected_Table.Square_Footage
FROM JOIN
Actual_Table.Organizational_Entity=

Projected_Table.Organizational_Entity

WHERE Actual_TABLE.Actual =‘A’ AND
Projected_TABLE.Projected=‘P’ AND
Actual_TABLE.Time_Period=2009 AND
Projected_TABLE.Time Period=2009

The query of Tables 1-5 are generated in an SQL querying language; however, it should be readily apparent that any of these queries may be generated in any suitable language or suitable querying technique.

The transaction database manager 103 extracts data from the transaction database 102 based on the query 212 and returns a query result 212 to the processor 106. The processor 106 uses the data provided in the query result 212 to calculate the performance forecast, which includes the calculation of the square footage and costs for each real property asset under the control of the selected business unit for the years the business unit or organization is contractually obligated to hold each real property asset up to the selected maximum year provided in the projected asset data 204. The processor 106 sums up the square footage and cost calculations of each real property asset and generates total square footage and cost figures of the real property portfolio based on past and future years. The processor 106 also combines the total square footage and cost figures with organizational performance measures, which were included in the query result 212, to calculate key performance ratios. The key performance ratios are those generally used in the real estate industry to measure real property asset or portfolio performance and may include, for example, square footage per organizational member, cost per square footage, sales per square foot, cost per sales, cost per organizational member, and sales per organizational member. The processor 106 sends these values to user interface 104 as the performance forecast 214.

The user interface 104 displays the performance forecast 214 in a manner that enables the officer of the organization to easily analyze and interpret the performance forecast. In particular, the user interface 104 may display the performance forecast 214 in a number of different views.

FIG. 4 illustrates a summary view 400 used to display the performance forecast 214 in accordance with exemplary embodiments of the invention. In the summary view 400 for example, historical and future data related to the real property portfolio may be displayed to the officer based on a time period specified by the officer. The time period may include quarterly, monthly, or yearly values. The future real property portfolio data is displayed chronologically along side the historical real property portfolio data (402). The future real property portfolio data is presented along with key historical and projected organizational portfolio measures, which include sales values, head-count or organizational member values, and operating expense values (404). In addition, the summary view enables the officer to analyze the historical and future real property portfolio data along with third party benchmarks (406). Furthermore, the summary view 400 provides trend analysis windows, which show a year-over-year or percent variance for each portfolio and performance measurement and ratio displayed (408, 410). Visual queues are provided to assist the officer to interpret the results with greater efficiency and accuracy by indicating whether a metric or calculated value is moving in a desirable direction. The summary view 400 also includes a field that indicates the effect the projected asset data 204 may have on the performance of the portfolio (412).

FIG. 5 illustrates a detailed view 500 used to display the performance forecast 214 in accordance with exemplary embodiments of the invention. In the detailed view 500, for example, the user interface 104 displays minute details associated with each real property asset that the processor 106 used to calculate the performance forecast 214 and generate the current and future real estate portfolio asset data in the summary view 410. The minute details are provided at the smallest asset measurement unit provided in the organization's portfolio such as location information and specific space details (502), for example. For each real property asset, for example, the detailed view 500 displays an ownership type which describes whether the asset is leased or owned, the square footage of the asset, a square footage cost rate, and a contract end date or a termination date of use or ownership of the asset (504). The detailed view 500 includes a plan of action option that enables the officer to prescribe a hypothetical (future) action to a specific real estate asset that currently exists in the organization's portfolio (506). The officer prescribes the action by selecting whether the contract for the asset will be extended, expanded, or closed-out. Based on the selected plan of action, the user interface 104 displays a field to allow the officer to enter additional data (508). This additional data includes, for example, square footage of the asset contract term, and rate values. Displaying the asset information in this manner enables the officer to see every data value that is used to generate summary calculations and enables even the smallest asset spaces to be optimized.

The system 100 enables the officer to modify the future real property portfolio data shown in both the summary view 400 and detailed view 500. In particular, the future portfolio data may be modified at an asset level or a portfolio level. The real estate asset portfolio data may be modified at an asset level through the plan of action option provided in the detailed view 500. Alternatively, the portfolio data may be modified at the portfolio level through the information entered through the summary view 400. Data values that are input by the officer to modify the future portfolio are sent to the processor 106 which sends this information to the planning database 114.

At the asset level, for example, the officer may adjust the total square footage, square footage cost, and the end date of every existing real property asset. In addition, the asset level enables the officer to adjust the square footage, and the square footage rate and end occupancy date of groups internal and external to the organization. Further, the officer may adjust state, city, square footage, expected occupancy and termination dates, and square footage rate data in an effort to add additional properties that may not exist in a current portfolio but may be acquired by the organization in the future.

To adjust the total square footage value, square footage cost value, and end date of existing real estate property asset value; the officer may modify the information by selecting from a predefined list related to a particular asset. This predefined list may include such options as extending a lease, expanding a contract, or closing out a lease, for example. The officer may alter every real property asset that is associated with the real property portfolio. This capability enables any projected or hypothetical situation related to the real estate portfolio to be modeled. Through the user interface 104, the officer may also change an occupant or group that controls the real property asset.

To modify the future portfolio at the portfolio level, the officer may adjust key performance measures provided in the summary view by entering absolute numbers or percentage values.

FIG. 6 illustrates a sub-window 600 of the detailed view 500 in accordance with exemplary embodiments of the invention. The sub-window 600 displays information that includes the specific amount of square footage space being occupied by a specified business unit and costs that are attributable to the occupation of this space (602). The space being controlled by another group in the same organization. The sub-window 600 also includes the plan of action option in which the officer may prescribe a hypothetical action for a specific real property asset (604). The officer prescribes the action by selecting whether the contract for the asset will be extended, expanded or closed out. Based on the selected plan of action, the officer may enter additional data which may include square footage of the asset, contract term, and rate values.

FIG. 7 illustrates a sub-window 700 of the detailed view 500 in accordance with an exemplary embodiment of the invention. The sub-window 700 is related to third-party subleased real property assets of the organization. The sub-window 700 displays information that includes the specific amount of square footage being occupied by a third-party and any costs that are attributable to the occupation of this space (702).

The sub-window 700 also includes the plan of action option in which the officer may prescribe a hypothetical action for a specific real property asset (704). The officer prescribes the action by selecting whether the contract for the asset will be extended, expanded or closed out. Based on the selected plan of action, the officer may enter additional data which may include square footage of the asset, contract term, and rate values.

FIG. 8 illustrates a sub-window 800 of the detailed view 500 in accordance with an exemplary embodiment of the invention. The sub-window 800 is related to new assets or requirements that are not currently in the organization's portfolio. The detailed view 800 includes automatically generated information based on an input of industry measures, such as state and city information, and based on square footage rate data from the organization and third party sources.

FIG. 9 illustrates a sub-window 900 of the detailed view 500 in accordance with an exemplary embodiment of the invention. The sub-window 900 includes a series of graphs generated in relation to portfolio, and key performance metrics and measures shown in FIG. 4.

FIG. 10 illustrates a sub-window 1000 used to display the performance forecast 214 in a number of different views in accordance with an exemplary embodiment of the invention. The sub-window 1000 assists the officer assessing the quality of the projected decisions form summary view 400 by comparing the data displayed in the summary view with historical performance trend data. The processor 106 uses queried results 212 from the projected portfolio data structure 202 to generate historical organizational portfolio ratios, which may include but are not limited to real estate headcount per sales, square footage per headcount, and real estate cost per square footage ('1004). The processor 106 uses the generated organizational portfolio ratios starting from sales projections from query 212 to calculate a headcount, value square footage value and a real estate value. The sub-window 1000 graphically displays the calculated values and generated organizational performance and portfolio ratios with the future real property portfolio data chronologically along side the historical real property portfolio data (1002). Furthermore, the detailed view 1000 provides trend analysis windows, which show a year-over-year or percent variance for each portfolio and performance measurement and ratio displayed (1006). Visual queues are provided to assist the officer to interpret the results with greater efficiency and accuracy by indicating whether the projected performance is in line with the organization's historical trend performance.

The various features as described herein enables a user of any level of knowledge or interaction with an asset to understand the effect that certain decisions regarding that asset will have on an individual business unit of an organization or the organization as a whole. Furthermore, this system enables users to understand the relationships between certain assets and the specific objectives of the organizations various groups or business units. The various data and views provided by the system enables a user to accurately estimate the effect that a new asset may have on the viability or performance of a business unit or organization.

While the invention has been described with reference to specific embodiments, this description is merely representative of the invention and is not to be construed as limiting the invention. Various modifications and applications may occur to those skilled in the art without departing from the true spirit and scope of the invention as defined by the appended claims.

What is claimed is:

1. A system that models an asset portfolio and predicts performance thereof, comprising:
a database that stores asset and performance data;
a user interface configured to request asset and performance data of a group from the database based on a user input; and
a processor configured to generate a performance forecast by performing a trend analysis on the requested asset and performance data based on data associated with the group.

2. The system of claim 1, wherein the requested asset and performance data of the group includes current asset and performance data of the group and projected asset and performance data of the group.

3. The system of claim 3 wherein the current asset and performance data of the group includes current financial values of the group, current operational values of the group, current headcount values of the group, current real estate cost values of the group, and current square footage values of the group, strategic operational and financial data of the group, third party benchmarks, and industry values, and
wherein the projected asset and performance data of the group includes at least one of projected financial values of the group, projected operational values of the group, projected headcount values of the group, projected real estate cost values of the group, and projected square footage values of the group.

4. The system of claim 2, wherein the user interface sends the projected asset and performance data of the group to the database based on a user input and displays a graphical representation of the performance forecast.

5. The system of claim 4, wherein the graphical representation includes a summary view and a detailed view of the performance forecast.

6. The system of claim 5, wherein the summary view includes the projected asset and performance data of the group arranged chronologically alongside historical and current asset and performance data of the group, and trend analyses data, industry values, and third party benchmarks.

7. The system of claim 5, wherein the detailed view includes an entry for each data value used to generate the summary view.

8. The system of claim 1, wherein the memory extracts the current asset and performance values from other memory devices on a network.

9. A method for modeling an asset portfolio to predict performance thereof, comprising:
extracting asset and performance data of a group from a database;
calculating a performance forecast using the extracted asset and performance data of the group in a trend analysis calculation; and
displaying the performance forecast in a graphical interface.

10. The method of claim 9, comprising:
generating the database by extracting current asset and performance data from storage devices on a network, wherein the current asset and performance data includes current sales values, current headcount values, current real estate cost values, current square footage values, third party benchmarks, industry values, and strategic operational and financial data.

11. The method of claim 10, comprising:
querying each storage device to determine whether the current asset and performance data has changed; and
updating the database when the current asset and performance data has changed.

12. The method of claim 10, comprising:
sending projected asset and performance data of the group to the database, wherein the projected asset and performance data includes at least one of projected sales values, projected headcount values, projected cost values, projected square footage values, and projected industry values.

13. The method of claim 12, wherein the requested asset and performance data of the group includes the projected asset and performance data of the group, and a portion of the current asset and performance data stored in the database and associated with the group.

14. The method of claim 12, wherein the projected asset and performance data of the group is sent to the database in a first mode as absolute numbers or percentage values, and wherein the sent data modifies a summary view of the graphical interface.

15. The method of claim 12, wherein the projected asset and performance data of the group is sent to the database in a second mode modifies a detailed view of the graphical interface.

16. The method of claim 12, wherein the displaying the performance forecast comprises:
arranging projected asset and performance data of the group chronologically alongside historic and current asset and performance data of the group and trend analyses results.

17. The method of claim 11, wherein displaying the detailed view comprises:
arranging projected asset and performance data of the group, historic and current asset and performance data of the group, and trend analyses results so that each value used to generate the summary view is displayed.

18. A system that models an asset portfolio and predicts performance thereof, the system comprising:
means for storing the asset and performance data;
means for requesting asset and performance data of a group from the storing means based on a first user input;
means for generating a performance forecast by relating the requested asset and performance data of the group to strategic data of the group in a trend analysis calculation; and
display means for graphically displaying the performance forecast.

19. The system of claim 18, wherein the stored asset and performance data includes: current sales values for each group in an organization, current headcount values for each group in an organization, current cost values for each group in an organization, current square footage values for each group in an organization, strategic data for each group in an organization, third party benchmarks, and industry values.

20. The system of claim 19, wherein the requested asset and performance data of the group includes current asset and performance data of the group, and projected asset and performance data of the group, which includes at least one of projected group sales values, projected group headcount values, projected group cost values, projected group square footage values, and projected industry values.

21. The system of claim 20, wherein the storage means stores the current asset and performance data from storage devices on a network.

22. The system of claim 21, comprising:
means for monitoring the storage devices and updates the database when the current asset and performance data in the storage devices has changed.

23. The system of claim 20, wherein the interface means generates the projected asset and performance data of the group based on a second user input and sends the projected data to the database.

24. The system of claim 23, wherein the interface means modifies a summary view of the performance forecast displayed in the graphical interface by sending the projected asset and performance data of the group to the database in a first mode as absolute numbers or percentage values.

25. The system of claim 23, wherein the interface means modifies a detailed view the performance forecast displayed in the graphical interface by sending the projected asset and performance data of the group to the database in a second mode.

26. The system of claim 20, wherein the display means generates the graphical interface that displays the performance forecast by arranging projected asset and performance data of the group chronologically alongside current asset and performance data of the group and trend analyses results.

27. The system of claim 20, wherein the display means generates the graphical interface that displays the performance forecast by arranging projected asset and performance data of the group, current asset and performance data of the group, and trend analyses results so that each value used to generate the summary view is displayed.

28. A computer readable medium that stores a program for modeling an asset portfolio and predicts the performance thereof, the computer readable medium comprising:
an interface module that generates a user interface for sending projected asset and performance data of a group to a database, requesting the projected asset and performance data of the group and current asset and performance data of the group from the database, and displaying a graphical representation of a performance forecast based on relationships between the projected asset and performance data of the group and the current asset and performance data of the group;
a processing module that calculates the performance forecast by using the projected asset and performance data of the group, current asset and performance data of the group, and strategic data of the group through a trend analysis calculation; and
a display module that generates a graphical representation of the performance forecast.

29. The computer readable medium of claim 28, wherein the current asset and performance data of the group includes current sales values, current headcount values, current cost values, current square footage values, third party benchmarks, industry values, and the objective and strategic data associated with the user.

30. The computer readable medium of claim 28, wherein the projected asset and performance data of the group includes at least one of projected sales values, projected headcount values, projected cost values, projected square footage values, strategic data, and projected industry values.
